(19) United States
(12) Patent Application Publication
(10) Pub. No.: US 2023/0106296 A1
(43) Pub. Date: Apr. 6, 2023

(54) ACTIVE COMPOUND ATTACHMENT FOR PRESERVING PRODUCT IN A PACKAGE, AND METHOD OF MAKING AND USING SAME

(71) Applicant: CSP Technologies, Inc., Auburn, AL (US)

(72) Inventors: Michael A. Johnston, Marietta, GA (US); Angela Morgan, Atlanta, GA (US); Thomas Paul Gautreaux, Atlanta, GA (US)

(21) Appl. No.: 17/907,063

(22) PCT Filed: Mar. 26, 2021
(86) PCT No.: PCT/US21/70315

§ 371 Date: Sep. 22, 2022

Related U.S. Application Data
(60) Provisional application No. 63/000,341, filed on Mar. 26, 2020.

(51) Int. Cl. B65D 81/28; A23L 3/3427; A23L 3/3445; B65D 81/26

(52) U.S. Cl. CPC B65D 81/28; A23L 3/3427; A23L 3/3445; B65D 81/263; B65D 81/267; A23V 2002/00

(57) ABSTRACT

A method is described herein for slowing, inhibiting, and/or preventing the growth of microbes, or for killing microbes, within and/or on a product/good that is stored in a package. The method can include applying a film cover over a perforated portion of a package and securing the film cover to the package at the perimeter of the perforated portion with an adhesive or by heat stacking. The film cover can include a material for changing the atmosphere within the package. The package may be an existing pre-perforated package, or may be a package that requires perforation. If the package requires perforation, the method can further include perforating at least a portion of the package prior to positioning the film cover over the perforated portion. The film cover can be formed of a three-phase material or other material.

### CROSS-REFERENCE TO RELATED APPLICATIONS

This application claims priority to U.S. Provisional Patent Application No. 63/000,341, entitled “ACTIVE COMPOUND ATTACHMENT FOR PRESERVING PRODUCT IN A PACKAGE, AND METHOD OF MAKING AND USING SAME”, filed on Mar. 26, 2020, the contents of which are incorporated herein by reference in its entirety.

### FIELD OF THE DISCLOSED AND CLAIMED CONCEPT AND BACKGROUND OF THE DISCLOSED AND CLAIMED CONCEPT

### 1. Field of the Disclosed and Claimed Concept

This disclosed and claimed concept relates to methods for slowing, inhibiting, or preventing the growth of microbes, or for killing microbes, within and/or on a product/good that is stored in a package; and more particularly, to methods for preparing packages that slow, inhibit, and/or prevent the growth of microbes, and/or that or kill microbes, e.g., in food containers, using polymers entrained with antimicrobial releasing agents. This disclosed and claimed concept also relates to packages that slow, inhibit, and/or prevent the growth of microbes, and/or that kill microbes.

### 2. Description of the Related Art

Many items are preferably stored, shipped, and/or utilized in an environment that must be controlled and/or regulated. For example, in the moisture control field, containers and/or packages having the ability to absorb excess moisture trapped therein have been recognized as desirable. Likewise, in packaging products that carry a risk of contamination, e.g., food, it may be desirable to control the growth and proliferation of microbes.

Food products, particularly sliced or cut fresh foodstuffs such as meat, poultry, fruit, and vegetables are typically stored and sold in a supporting container, e.g., tray, that is overwrapped by a transparent plastic film, enabling visual inspection of the food products. These food products generally produce an exudate (i.e., juices), which can be a source for the growth of microbial agents. In addition, contaminants on processing equipment or on other surfaces with which the food products come into contact may remain with the food and proliferate while packaged. Similarly, food products may be contaminated even before the packaging process. For example, a tomato may have an opening in its skin through which unwanted microorganisms enter and replicate. Breakdown in the food handling process and/or cold chain management (e.g., refrigeration during food transport fails for a number of hours) can allow microbial growth on contaminated food, potentially leading to outbreaks of food-borne illness. As employed herein, the expression “a number of” and variations thereof shall refer broadly to any non-zero quantity, including a quantity of one. Regardless of the source or nature of microbial contamination in food, the shelf life and safety of the contaminated food products is adversely affected by contamination and proliferation of microbes.

One way that the food industry has addressed food preservation is to utilize antimicrobial agents as a component in packaging material that directly contact the food. However, such direct contact may be undesirable in some applications.

For certain applications, it is desirable to provide antimicrobial agents to release antimicrobial gas into a headspace of the food product package or container to control the growth of microbes, as compared to a solid or liquid component that requires direct contact with the stored food in order to be effective. However, there are challenges with providing the antimicrobial gas in the headspace. One such challenge is attaining a desired release profile of antimicrobial gas within the headspace during a designated time period. Failure to attain the appropriate release profile for a given product may result in a failure to achieve the desired shelf life for that product. Thus, there exists a need for improved delivery of antimicrobial agents to control, reduce, and/or substantially destroy microbial contamination in food packaging as well as other applications such as, but not limited to, packaging of sterilized disposable medical devices. A challenge in meeting this need is in maintaining an appropriate balance between providing sufficient antimicrobial gas in the package headspace to effectively control and/or kill pathogens while not “overdosing” the package headspace, which could adversely affect the quality of the product, e.g., by organoleptic degradation.

Polymer materials designed to achieve certain desirable antimicrobial effects have been developed. See for example, PCT/US2017/061389, the disclosures of which are incorporated herein by reference. However, putting such materials to use with existing packaging remains a challenge.

### SUMMARY OF THE DISCLOSED AND CLAIMED CONCEPT

The following summary is provided to facilitate an understanding of some of the innovative features unique to the embodiments disclosed and is not intended to be a full description. A full appreciation of the various aspects of the embodiments can be gained by taking the entire specification, claims, abstract and drawings as a whole.

A method is described herein that includes providing a package having an interior, an exterior, and a perforated portion for allowing gaseous flow between at least the interior and the exterior of the package, and attaching a film cover made of a material for changing the atmosphere within the package over the perforated portion of the package. In various aspects, the film cover may incorporate an active agent, which may be one or both of an antimicrobial agent and a desiccant, for example. In various aspects, the film cover material may be a three phase material that incorporates an active agent.

Also described herein is a method that includes providing a package having an interior and an exterior. In various aspects, at least a portion of the package has a number of perforations extending between the interior and exterior, and the perforated portion has a perimeter. The method further includes positioning a film cover having a peripheral surface over at least a portion of the perforated portion of the package, and securing the peripheral surface of the film cover to the perimeter of the perforated portion of the package.

In various aspects, the film cover has an upper side and a lower side, and securing the peripheral surface of the film cover to the perimeter of the perforated portion comprises applying an adhesive, or an adhesive coated backing material, to the lower side of the peripheral surface, and contacting the lower side of the peripheral surface to the perimeter of the perforated portion of the package.

In various aspects, the film cover has an upper side and a lower side, and securing the peripheral surface of the film cover to the perimeter of the perforated portion comprises applying an adhesive backed material to the upper side of the peripheral surface and to a part of the exterior of the package surrounding the perimeter of the perforated portion such that the adhesive backed material overlaps the upper side of the peripheral surface and the part of the package exterior.

In various aspects, securing the peripheral surface of the film cover to the perimeter of the perforated portion comprises heat staking the peripheral surface and the perimeter together.

A method is described herein that comprises perforating at least a portion of the surface of a package, applying a film cover over at least a portion of the perforated portion of the package, and securing the film cover to the package at the perimeter of the perforated portion, wherein the film cover includes a material for changing the atmosphere within the package.

A method is also described that comprises providing a pre-perforated package having perforations in at least a portion thereof, applying a film cover over at least a portion of the perforated portion of the package, and securing the film cover to the package at the perimeter of the perforated portion, wherein the film cover includes a material for changing the atmosphere within the package.

In various aspects of the method, the film cover may be made of a material having anti-microbial properties. In various aspects of the method, the film cover may be made of a material having desiccant properties. In various aspects of the method, the film cover may be made of a three phase material that incorporates an active agent. The active agent may be one or both of an antimicrobial agent and a desiccant.

Also described herein is a package. The package includes an exterior surface and an interior surface. At least a portion of the package has perforations extending between the interior and the exterior surfaces, and the perforated portion has a perimeter. The package also includes a film cover having a peripheral surface secured to the perimeter of the perforated portion. The film cover is made of a material for changing the atmosphere within the package, preferably a three phase material, and more preferably a material having one or more of anti-microbial properties, releasing properties, and desiccant properties, for example.

In various aspects, the package may further include a backing material in overlapping adhesive contact with an upper surface of the peripheral surface and a part of the exterior of the package surrounding the perimeter of the perforated portion for securing the film cover peripheral portion to the perimeter of the perforated portion. Alternatively, the peripheral surface of the film cover may be secured to the perimeter of the perforated portion by heat staking.

It should be understood that this disclosure is not limited to the embodiments disclosed in this Summary, and it is intended to cover modifications that are within the spirit and scope of the disclosed and claimed concept, as defined by the claims.

### BRIEF DESCRIPTION OF THE DRAWINGS

The characteristics and advantages of the present disclosure may be better understood by reference to the accompanying figures.

FIG. 1A shows an exemplary package having perforations over at least a portion thereof and an embodiment of a film cover positioned over the perforated portion. The embodiment of the film cover shown in FIG. 1 has an optional polymer backing for securing the film cover to an area of the package surrounding the perimeter of the perforated portion.

FIG. 1B is a schematic illustration of a side section view, taken along the line 1-1 of FIG. 1A, of a surface of the package having a film cover secured to the perimeter of a perforated portion of the package with the use of a backing material situated between the surface of the package and the film cover.

FIG. 1C is a view similar to FIG. 1B, except depicting a surface of the package having a film cover secured to the perimeter of a perforated portion of the package with heat staking between the film cover and the package.

FIG. 1D is a view similar to FIG. 1B, except depicting a surface of the package having a film cover secured to the perimeter of a perforated portion of the package with the use of a backing material overlying both the surface of the package and the film cover.

FIG. 2 is a perspective view of an exemplary portion of the film cover formed of an entrained polymer according to an optional embodiment of the disclosed and claimed concept.

FIG. 3 is a cross section taken along line 2-2 of FIG. 2;

FIG. 4 is a cross sectional view similar to that of FIG. 3, showing an alternative embodiment of the film cover formed of another embodiment of an entrained polymer;

FIG. 5 is a schematic sectional illustration of an entrained polymer according to an optional embodiment of the film cover, in which the active agent is an antimicrobial gas releasing material that is activated by contact with a selected material (e.g., moisture).

FIG. 6 is a cross sectional view of a sheet or film formed of an entrained polymer according to an optional embodiment of the film cover, adhered to an optional polymer backing.

FIG. 7 is a cross section of a package that may be formed using an entrained polymer according to an optional embodiment of the disclosed and claimed concept.

### DESCRIPTION OF THE PREFERRED EMBODIMENTS

While systems, devices and methods are described herein by way of examples and embodiments, those skilled in the art recognize that the presently disclosed technology is not limited to the embodiments or drawings described. Rather, the presently disclosed technology covers all modifications, equivalents and alternatives falling within the spirit and scope of the appended claims. Features of any one embodiment disclosed herein can be omitted or incorporated into another embodiment.

Any headings used herein are for organizational purposes only and are not meant to limit the scope of the description or the claims. As used herein, the word “may” is used in a permissive sense (i.e., meaning having the potential to) rather than the mandatory sense (i.e., meaning must). The terminology includes the words noted above, derivatives thereof and words of similar import.

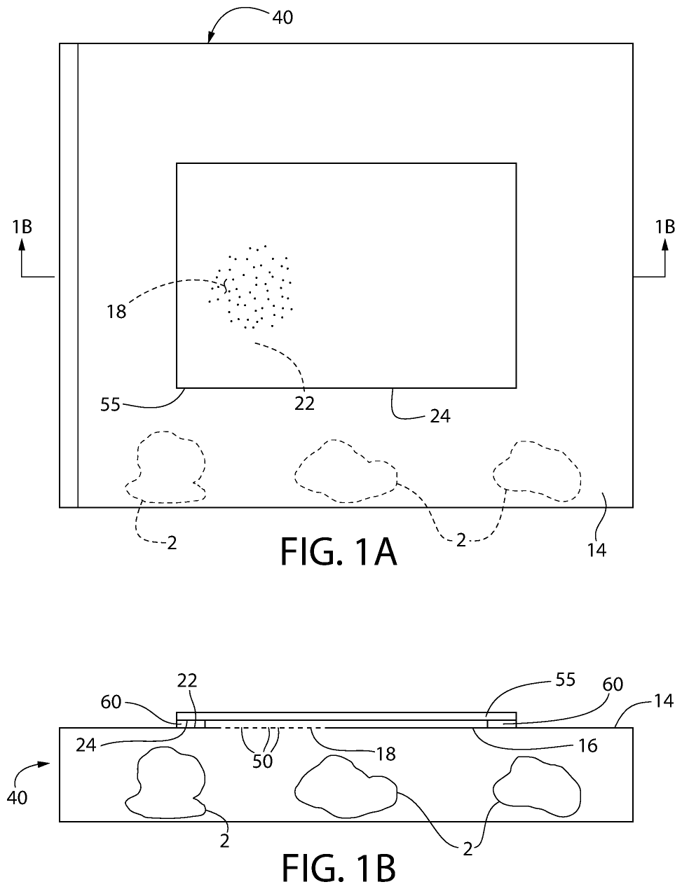

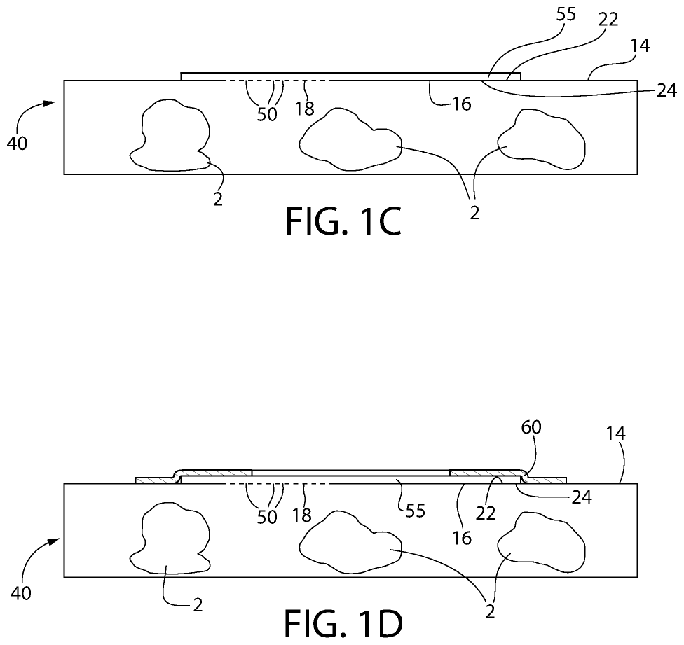

A method for preparing a package that slows, inhibits, or prevents the growth of microbes, kills microbes, or both kills and slows, inhibits or prevents the growth of microbes is described herein. With reference to the exemplary package and components thereof in FIGS. 1A and 1B and a product 2 contained therein, the method optionally includes attaching a film cover 55 to a perforated package 40, or to a perforated portion 18 of a package 40. In various aspects, the film cover 55 may be attached to the perforated portion 18 of the package 40 on the exterior 14 of the package. In various aspects, the film cover 55 may be attached to the perforated portion 18 of the package on the interior 16 of the package 40. Attaching the film cover 55 may include securing the peripheral surfaces 24 of the film cover 55 that face and contact the surface of the package (interior surface 14 or exterior surface 16, depending on the choice of attachment suitable for the intended contents of the package) to the perimeter 22 of the perforated portion 18 of the package 40.

The method to attach a film cover 55 to an at least partially perforated package 40 may include attaching the film cover 55 to an existing perforated or partially perforated package, such as a bag, pouch, or another flexible or rigid container as more fully defined below, while avoiding direct contact with the contents of the package. The method may be carried out as part of one of the several current processes of filling such packages, and may be a continuous process or a batch process.

In various aspects, the method may comprise first perforating at least a portion 18 of a package 40, and then attaching a film cover 55 over the perforated portion 18 of the package 40, and then securing the film cover 55 to the package 40. Securing the film cover 55 may include securing at least or only the peripheral surfaces 24 of the film cover 55 that face toward and contact the surface of the package (interior surface 14 or exterior surface 16, depending on the choice of attachment suitable for the intended contents of the package) to the perimeter 22 of the perforated portion 18 of the package 40. The package may be thereafter filled with the desired contents. As a result of the presently disclosed technology, it is advantageous that there is no need for direct contact with the contents of the package during the preparation of the perforated and covered package. The method may be carried out as a continuous process or a batch process.

The film cover 55 in various aspects of the method may be made of a three phase material, preferably or optionally an anti-microbial material, as defined and discussed below.

Before further describing the details of the method and the package prepared by the method, the meaning of certain terms used herein is as follows.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the term “active” is defined as capable of acting on, interacting with, or reacting with a selected material (e.g., moisture or oxygen) according to the disclosed and claimed concept. Examples of such actions or interactions may include absorption, adsorption, or release of the selected material. Another example of “active” is an agent capable of acting on, interacting with or reacting with a selected material in order to cause release of a released material.

As used herein, the term “active agent” is defined as a material that (1) is preferably immiscible with the base polymer and when mixed and heated with the base polymer and the channeling agent, will not melt, i.e., has a melting point that is higher than the melting point for either the base polymer or the channeling agent, and (2) acts on, interacts, or reacts with a selected material. The term “active agent” may include but is not limited to materials that absorb, adsorb, or release the selected material(s). The active agents of primary focus in this specification are those that release antimicrobial gases, preferably chlorine dioxide gas.

The term “antimicrobial releasing agent” refers to an active agent that is capable of releasing a released antimicrobial material, e.g. in gas form. This active agent may include an active component and other components, such as a catalyst and trigger, in a formulation (e.g., powdered mixture) configured to release the antimicrobial gas. A “released antimicrobial material” is a compound that inhibits or prevents the growth and proliferation of microbes and/or kills microbes, e.g., chlorine dioxide gas. The released antimicrobial material is released by the antimicrobial releasing agent. By way of example only, an antimicrobial releasing agent may be triggered (e.g., by chemical reaction or physical change) by contact with a selected material (such as moisture). For example, moisture may react with an antimicrobial releasing agent to cause the antimicrobial releasing agent to release a released antimicrobial material.

As used herein, the term “base polymer” is a polymer optionally having a gas transmission rate of a selected material that is substantially lower than, lower than, or substantially equivalent to, that of the channeling agent. By way of example, such a transmission rate is a water vapor transmission rate in embodiments where the selected material is moisture and the active agent is an antimicrobial gas releasing agent that is activated by moisture. This active agent may include an active component and other components in a formulation configured to release the antimicrobial gas. The primary function of a base polymer is to provide structure for an entrained polymer.

Suitable base polymers for use in the disclosed and claimed concept include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane, and polyacetal, or copolymers or mixtures thereof.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

As used herein, the term “channels” or “interconnecting channels” is defined as a number of passages formed by the channeling agent that penetrate through the base polymer and may be interconnected with each other.

As used herein, the term “entrained polymer” is defined as a monolithic material formed of at least a base polymer with an active agent and optionally also a channeling agent entrained or distributed throughout. An entrained polymer thus includes two-phase polymers, which would be without a channeling agent, and three-phase polymers, which include a channeling agent.

As used herein, the term “monolithic,” “monolithic structure” or “monolithic composition” is defined as a composition or material that does not consist of a plurality of discrete macroscopic layers or portions. Accordingly, a “monolithic composition” does not include a multi-layer composite.

As used herein, the term “phase” is defined as a portion or component of a monolithic structure or composition that is uniformly distributed throughout, to give the structure or composition its monolithic characteristics.

As used herein, the term “selected material” is defined as a material that is acted upon, by, or interacts or reacts with an active agent and is capable of being transmitted through the channels of an entrained polymer. For example, in embodiments in which a releasing material is the active agent, the selected material may be moisture that reacts with or otherwise triggers the active agent to release a releasing material, such as an antimicrobial gas.

As used herein, the term “three phase” is defined as a monolithic composition or structure comprising three or more phases. An example of a three phase composition according to the disclosed and claimed concept is an entrained polymer formed of a base polymer, active agent, and channeling agent. Optionally, a three phase composition or structure may include an additional phase, e.g., a colorant, but is nonetheless still considered “three phase” because of the presence of the three primary functional components.

Furthermore, the terms “package,” “packaging,” and “container” may be used interchangeably herein to indicate an object that holds or contains a good, e.g., food product and foodstuffs, or an object that is capable of holding or containing a good. Optionally, a package may include a container with a product stored therein. Non-limiting examples of a package, packaging, and container include a tray, box, carton, bottle receptacle, vessel, pouch, and flexible bag. The package, packaging, or container may be rigid, semi-rigid, or flexible. A pouch or flexible bag may be made from, e.g., polypropylene or polyethylene. The package or container may be closed, covered, and/or sealed using a variety of mechanisms including a cover, a lid, lidding sealant, an adhesive, and a heat seal, for example. The package or container is composed or constructed of various materials, such as plastic (e.g., polypropylene or polyethylene), paper, Styrofoam, glass, metal, and combinations thereof. In one optional embodiment, the package or container is composed of a rigid or semi-rigid polymer, optionally polypropylene or polyethylene, and preferably has sufficient rigidity to retain its shape under gravity.

### Exemplary Entrained Polymers

Conventionally, desiccants, oxygen absorbers, and other active agents have been used in raw form, e.g., as loose particulates housed in sachets or canisters within packaging, to control the internal environment of the package. For many applications, it is not desired to have such loosely stored active substances. Thus, the present application provides active entrained polymers comprising active agents, wherein such polymers can be extruded and/or molded into a variety of desired forms, e.g., container liners, plugs, film sheets, pellets, and other such structures. Optionally, such active entrained polymers may include channeling agents, such as polyethylene glycol (PEG), which form channels between the surface of the entrained polymer and its interior to transmit a selected material, e.g., moisture, to the entrained active agent, e.g., desiccant to absorb the moisture. As explained above, entrained polymers may be two phase formulations, i.e., comprising a base polymer and active agent, without a channeling agent, or three phase formulations, i.e., comprising a base polymer, active agent, and channeling agent. Entrained polymers are described, for example, in U.S. Pat. Nos. 5,911,937, 6,080,350, 6,124,006, 6,130,263, 6,194,079, 6,214,255, 6,486,231, and 7,005,459, and U.S. Pat. Pub. No. 2016/0039955, each of which is incorporated herein by reference as if fully set forth.

FIGS. 1A and 1B illustrate an exemplary package showing a film cover 55 that is situated over the exterior 14 of a perforated portion 18 of a package 40. In the embodiment shown, the film cover 55 is attached to the perimeter 22 of the perforated portion 18 by use of an exemplary backing material 60.

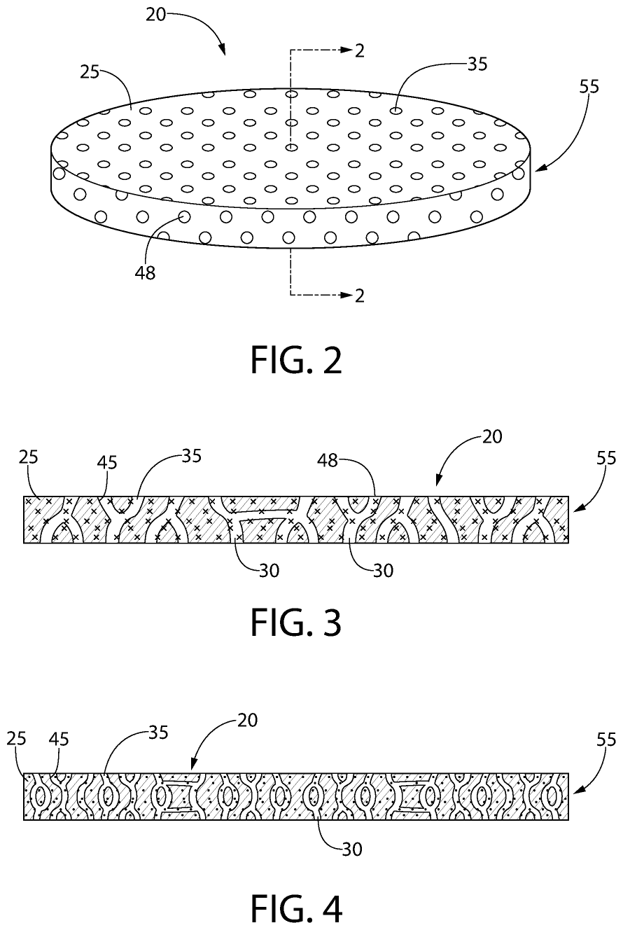

FIGS. 2-7 illustrate exemplary materials for use as the film cover 55. The exemplary materials, in various aspects, include entrained polymers 20. FIGS. 2-7 also illustrate various packaging assemblies formed of entrained polymers according to certain embodiments of the disclosed and claimed concept. The entrained polymers 20 each include a base polymer 25 and an active agent 30 and, optionally, a channeling agent 35. As shown, the channeling agent 35 forms a number of interconnecting channels 45 through the entrained polymer 20. At least some of the active agent 30 is contained within these channels 45, such that the channels 45 communicate between the active agent 30 and the exterior of the entrained polymer 20 via channel openings 48 formed at the outer surfaces of the entrained polymer 25. The active agent 30 can be, for example, any one or more of a variety of releasing materials, as described in further detail below. While a channeling agent, e.g., 35, is preferred, the disclosed and claimed concept broadly includes entrained polymers that optionally do not include a channeling agent.

Suitable channeling agents include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent 35 can be, for example, a water insoluble polymer, such as a propylene oxide polymerisate-monobutyl ether, which is commercially available under the trade name Polyglykol B01/240, produced by CLARIANT. In other embodiments, the channeling agent could be a propylene oxide polymerisate monobutyl ether, which is commercially available under the trade name Polyglykol B01/20, produced by CLARIANT, propylene oxide polymerisate, which is commercially available under the trade name Polyglykol D01/240, produced by CLARIANT, ethylene vinyl acetate, nylon 6, nylon 66, or any combination of the foregoing.

Entrained polymers with antimicrobial releasing agents are further described below.

### Antimicrobial Releasing Agents and Optional Entrained Polymer Formulations Incorporating the Same

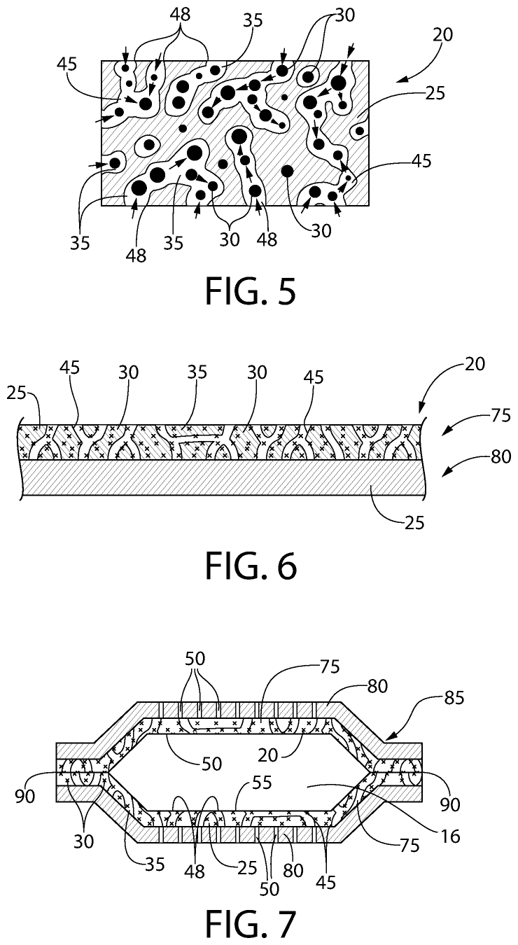

Suitable active agents according to the disclosed and claimed concept include antimicrobial releasing agents. FIG. 5 illustrates an embodiment of an entrained polymer 20, in which the active agent 30 is an antimicrobial releasing agent. The arrows indicate the path of a selected material, for example moisture or another gas, from an exterior of the entrained polymer 20, through the channels 45, to the particles of active agent 30 (in this case, an antimicrobial releasing agent). Optionally, the antimicrobial releasing agent reacts with or is otherwise triggered or activated by the selected material (e.g., by moisture) and in response releases a released antimicrobial material, preferably in gas form.

The antimicrobial agents that are used herein include volatile antimicrobial releasing agents, non-volatile antimicrobial releasing agents, and combinations thereof.

The term “volatile antimicrobial releasing agent” includes any compound that, when coming into contact with a liquid, e.g., water or the juice from a food product, produces a gas and/or gas phase such as vapor of released antimicrobial agent. As will be discussed in greater detail below, the volatile antimicrobial releasing agent is generally used in a closed system so that the released antimicrobial material, e.g., gas and/or vapor, does not escape. Examples of volatile antimicrobial releasing agents include, but are not limited to, origanum, basil, cinnamaldehyde, chlorine dioxide-releasing agent, e.g., a combination of sodium chlorite, a catalyst, and a trigger, carbon dioxide-releasing agents, ozone-releasing agents, vanillin, vanillic acid, cilantro oil, clove oil, horseradish oil, mint oil, rosemary, sage, thyme, wasabi or an extract thereof, a bamboo extract, an extract from grapefruit seed, an extract of Rheum palmatum, an extract of Coptis chinesis, lavender oil, lemon oil, eucalyptus oil, peppermint oil, Cananga odorata, Cupressus sempervirens, Curcuma longa, Cymbopogon citratus, Eucalyptus globulus, pinus radiate, Piper crassinervium, Psidium guayava, Rosmarinus officinalis, Zingiber officinale, thyme, thymol, allyl isothiocyanate (AIT), hinokitiol, carvacrol, eugenol, α-terpinol, sesame oil, or any combination of the foregoing compounds.

The term “non-volatile antimicrobial agent” includes any compound that, when coming into contact with a liquid (e.g., water or the juice from a food product), produces minimal to no vapor of antimicrobial agent. Examples of non-volatile antimicrobial agents include, but are not limited to, ascorbic acid, a sorbate salt, sorbic acid, citric acid, a citrate salt, lactic acid, a lactate salt, benzoic acid, a benzoate salt, a bicarbonate salt, a chelating compound, an alum salt, nisin, ε-polylysine 10%, methyl and/or propyl parabens, or any combination of the foregoing compounds. The salts include the sodium, potassium, calcium, or magnesium salts of any of the compounds listed above. Specific examples include calcium sorbate, calcium ascorbate, potassium bisulfite, potassium metabisulfite, potassium sorbate, or sodium sorbate.

Preferred features of antimicrobial releasing agents used according to an aspect of the disclosed and claimed concept include any one or more of the following characteristics: (1) they volatize at refrigerated temperatures; (2) they are food safe and edible in finished form; (3) they may be incorporated safely into an entrained polymer formulation or other mechanism for release; (4) they are shelf stable in long term storage conditions; (5) they release the released antimicrobial material only once a package in which the agent is disposed is sealed with product disposed in the package; (6) they do not affect a stored food product organoleptically when they are formulated and configured to achieve a desired release profile within the package; and (7) they are preferably acceptable under applicable governmental regulations and/or guidelines pertaining to food packaging and finished food labeling.

### Chlorine Dioxide Releasing Antimicrobial Releasing Agents

In one aspect of the disclosed and claimed concept, preferred antimicrobial releasing agents are volatile antimicrobial agents that release chlorine dioxide (ClO₂) in gas form as the released antimicrobial material. For example, the antimicrobial releasing agent may be a compound or formulation comprising an alkaline chlorite, such as, e.g. sodium chlorite or potassium chlorite, a catalyst, and a trigger, e.g., in the form of a powder, which in combination are triggered or activated by moisture to cause the agent to release chlorine dioxide. One exemplary antimicrobial releasing agent is provided under the brand ASEPTROL 7.05 by BASF Catalysts LLC. This material and preparation of the same is described in U.S. Pat. No. 6,676,850, which is incorporated herein by reference in its entirety. Example 6 of the aforementioned patent describes a formulation that is particularly suitable as an antimicrobial releasing agent, according to an optional aspect of the disclosed and claimed concept.

Optionally, a suitable antimicrobial releasing agent, which is based on Example 6 of U.S. Pat. No. 6,676,850 and is configured to release chlorine dioxide gas upon activation by moisture, may be prepared as follows.

The antimicrobial releasing agent includes a formulation comprising sodium chlorite (as the active component), a base catalyst, and a trigger. The catalyst and trigger preparations are made separately, then combined together and ultimately combined with the sodium chlorite.

The base catalyst is optionally made by first preparing a 25-30 wt. % sodium silicate solution (SiO₂: Na₂O proportion of 2.0 to 3.3 by weight). That solution is mixed into an aqueous slurry of 28-44 wt. % Georgia Kaolin Clay (particle size diameter of about 80% less than one micrometer), wherein the sodium silicate solution is 2 wt. % of the slurry. The slurry is oven dried at 100° C. to generate agglomerates or microspheres of about 70 μm in size. 300 g of these microspheres are impregnated with 280 g of 2.16N sulfuric acid solution. That mixture is then dried at 100° C. Next, the dried mixture undergoes a calcine process at 350° C. for three hours, followed by an additional calcine process at 300° C. in a sealed glass jar with the seal wrapped with tape. This mixture forms the base catalyst.

Next, 84.6 g of the base catalyst are mixed with 10.1 g of the trigger, dry calcium chloride. This base catalyst and trigger mixture is ground with mortar and pestle at ambient room temperature. This mixture is dried for two hours at 200° C. The base catalyst and trigger mixture is then cooled to room temperature in a sealed glass jar with tape wrapped around the seal.

Finally, the base catalyst and trigger mixture is combined with 5.3 g of sodium chlorite, which is the active component of the active agent. The full mixture is then ground with mortar and pestle at room temperature, thus forming an optional embodiment of an antimicrobial releasing agent. The antimicrobial releasing agent is then deposited in a sealed glass jar with tape wrapped around the seal to preserve it and keep it essentially free of moisture, which would prematurely activate it, e.g., to release chlorine dioxide gas.

Optionally, the antimicrobial releasing agent is a component of an entrained polymer, preferably a three phase polymer comprising the active agent, e.g., 40%-70% by weight, a base polymer, and a channeling agent. Optionally, such entrained polymer is in the form of a film 75 configured in use, a desired shape sufficient to fully cover the perforated portion 18 of the package 40 plus an amount of additional surface along the periphery 24 of the film 75 sufficient to cover, and be secured to, a facing surface of the package surrounding the perimeter 22 of the perforated portion 18 of the package. The film cover 55 is disposed over the perforated portion 18 of packaging that contains fresh foodstuffs, e.g., meat or produce.

It is generally believed that the higher the antimicrobial releasing agent concentration in an entrained polymer mixture, the greater the absorption, adsorption, or releasing capacity of the final composition. However, too high an active agent concentration may cause the entrained polymer to be too brittle. This may also cause the molten mixture of active agent, base polymer, and (if used) channeling agent to be more difficult to either thermally form, extrude or injection mold. In one embodiment, the antimicrobial releasing agent loading level or concentration can range from 10% to 80%, preferably 40% to 70%, more preferably from 40% to 60%, and even more preferably from 45% to 55% by weight with respect to the total weight of the entrained polymer. Optionally, the channeling agent may be provided in a range of 2% to 10% by weight, preferably about 5% by weight. Optionally, the base polymer may range from 10% to 50% by weight of the total composition, preferably from 20% to 35% by weight. Optionally, a colorant is added, e.g., at about 2% by weight of the total composition.

In one embodiment, an entrained polymer may be a three phase formulation including 50% by weight of ASEPTROL 7.05 antimicrobial releasing agent in the form of the powdered mixture, 38% by weight ethyl vinyl acetate (EVA) as a base polymer, and 12% by weight polyethylene glycol (PEG) as a channeling agent.

FIG. 2 shows a perspective view of a cover 55 constructed of an entrained polymer 20. As aforementioned, the entrained polymer 20 includes a base polymer 25, a channeling agent 35 and an active agent 30.

FIG. 3 shows a cross-sectional view of the cover 55 shown in FIG. 2. In addition, FIG. 3 shows that the entrained polymer 20 has been solidified such that the channeling agent 35 forms a number of interconnecting channels 45 to establish passages throughout the solidified film cover 55. At least some of the active agent 30 is contained within the channels 45, such that the channels 45 communicate between the active agent 30 and the exterior of the entrained polymer 20 via channel openings 48 formed at outer surfaces of the entrained polymer 20.

FIG. 4 illustrates an embodiment of a cover 55 having similar construction and makeup to the cover 55 of FIG. 3, where interconnecting channels 45 are finer as compared to those shown in FIG. 3. This can result from the use of a dimer agent (i.e., a plasticizer) together with a channeling agent 35. The dimer agent may enhance the compatibility between the base polymer 25 and the channeling agent 35. This enhanced compatibility is facilitated by a lower viscosity of the blend, which may promote a more thorough blending of the base polymer 25 and channeling agent 35 which, under normal conditions, can resist combination into a uniform solution. Upon solidification of the entrained polymer 20 having a dimer agent added thereto, the interconnecting channels 45 which are formed therethrough have a greater dispersion and a smaller porosity, thereby establishing a greater density of interconnecting channels throughout the cover 55.

Interconnecting channels 45, such as those disclosed herein, facilitate transmission of a desired material, such as moisture, gas, or odor, through the base polymer 25, which generally acts as a barrier to resist permeation of these materials. For this reason, the base polymer 25 itself acts as a barrier substance within which an active agent 30 may be entrained. The interconnecting channels 45 formed of the channeling agent 35 provide pathways for the desired material to move through the entrained polymer. Without these interconnecting channels 45, it is believed that at most only relatively small quantities of the desired material would be transmitted through the base polymer 25 to or from the active agent 30. Additionally, wherein the desired material is transmitted from the active agent 30, it may be released from the active agent 30, for example in embodiments in which the active agent 30 is a releasing material, such as an antimicrobial gas releasing material.

FIG. 6 illustrates an active sheet or film 75 formed of the entrained polymer 20 used in combination with a barrier sheet 80 to form a composite, according to an aspect of the disclosed and claimed concept. The characteristics of the active sheet 75 are similar to those described with respect to the film cover 55 shown in FIGS. 2 and 3. The barrier sheet 80 may be a substrate such as foil and/or a polymer, such as a container wall, with low moisture or oxygen permeability. The barrier sheet 80 is compatible with the active sheet 75 and thus is configured to thermally bond to the active sheet 75 when the active sheet 75 solidifies after dispensing.

FIG. 7 illustrates an embodiment in which the two sheets 75 and 80 are combined to form a packaging wrap having active characteristics at an interior surface 16 formed by the entrained polymer 20/active sheet 75 and having vapor resistant characteristics at an exterior surface formed by the barrier sheet 80. Barrier sheet 80 has perforations 50 through at least a portion thereof, and in various aspects, through substantially all of the sheet 80. Film 75 is positioned on the interior surface 16 of the package formed by joining the film 75 and barrier sheet 80 to be laminated together to form a laminate or composite.

In one embodiment, as shown in FIG. 7, the sheets 75 and 80 of FIG. 6 are joined together to form an active package 85. As shown, two laminates or composites are provided, each formed of an active sheet 75 joined with a barrier sheet 80. The sheet laminates are stacked, with each active sheet 75 facing the other, so as to be disposed adjacent an interior 16 of the package, and are joined at a sealing region 90 that is formed about a perimeter of the sealed region of the package interior 16. Optionally, the films 75 may be joined together with an adhesive applied to sealing region 90.

In various aspects, the film 75, when cut into a film cover 55, may be attached to an interior surface 16 or exterior surface 14 of the package 40, for example at the perimeter 22 of the perforated portion 18 of the package with an adhesive applied to one or both of the peripheral surface 24 of film cover 55 and the perimeter 22 of the perforated portion 18. Alternatively, the film 75 or the film cover 55 may be heat staked, i.e., without an adhesive, to a surface at the perimeter 22 of the perforated portion 18 of the package. The process of heat staking film onto a substrate is known in the art and is described in detail in U.S. Pat. No. 8,142,603, which is incorporated herein by reference in its entirety.

The size and thickness of the film can vary. In certain embodiments, the film has a thickness of approximately 0.3 mm. Optionally, the film may range from 0.1 mm to 1.0 mm, more preferably from 0.3 mm to 0.6 mm. Optionally, the entrained polymer film 75 is heat staked to the package 40, as shown in FIG. 1. Advantageously, heat staking could allow the film 75, or film cover 55, to adhere permanently to the desired location on or in the package without the use of an adhesive. An adhesive may be problematic in some circumstances because it may release unwanted volatiles in the food-containing headspace. Aspects of a heat staking process that may be used in accordance with optional embodiments of the disclosed and claimed concept are disclosed in U.S. Pat. No. 8,142,603, as referenced above. Heat staking, in this instance, refers to heating a sealing layer substrate on the sidewall while exerting sufficient pressure on the film and sealing layer substrate to adhere the film to the container wall.

In various aspects, the method may be used with existing stocks of perforated or partially perforated packaging.

An optional way to attach the film cover 55 to an already formed container or package 40 without having the film cover 55 situated in direct contact with the contents of the package includes cutting the film cover 55 into a desired configuration sufficient in area to cover both the perforated portion 18 of the package and an area surrounding the perimeter 22 of the perforated portion sufficient to attach the film cover to the surface of the package 40. The size and shape of the film cover and the size and shape of the peripheral surface area 24 needed for attachment will vary depending upon the size and shape of the perforated portion 18 and the area needed for attaching the peripheral portion 24 of the film cover 55 to the perimeter of the perforated portion 18. In various aspects, the peripheral surface 24 of the film cover that is intended to contact the perimeter 22 of the perforated portion is coated with an adhesive. In alternative aspects, a backing material 60 is attached to the peripheral surface 24 of the film cover 55 that is intended to contact the perimeter 22 of the perforated portion 18. The backing material 60 may be coated with an adhesive or may be an adhesive material.

In another aspect, the backing material 60 in the exemplary form of a layer of an adhesive-coated film is attached to a portion of the peripheral surface 24 of the film cover that is intended to contact the perimeter 22 of the perforated portion 18. Alternatively, the backing material 60 may be positioned over a part of the exterior surface of the package 40 that surrounds the perimeter of the perforated portion 18 as well as a portion of the peripheral surface 24 of the film cover 55 along the edges thereof that overlies the package 40, such that the backing material 60 overlaps the portion of the peripheral surface 24 and the part of the package to secure the film cover 55 to the package 40.

In various aspects of the method, the film cover 55, cut to the desired size and shape and coated with an adhesive, adhesive backing, or a layer of a film or backing material coated with an adhesive, is placed over the perforated portion 18 to cover fully the perforated portion 18. The peripheral surface 24 is pressed against the perimeter 22 of the perforated portion 18 to seal the perimeter 22 together with the film cover 55 to thereby create a seal between the film cover 55 and the package 40. In certain aspects, the film cover may be attached to the exterior surface 14 of a package 40. In certain aspects, the film cover may be attached to the interior surface 16 of a package 40. When placed on the interior surface 16 of the package 40 to cover the perforations from the inside, the film is preferably a permeable film. Whether placed on the inside or the outside of the package, the film cover 55 is applied over the perforated portion 18 either sealed or loose to the package 40.

In various aspects of the method, the film cover 55, cut to the desired size and shape, but not coated with an adhesive, is positioned over the perforated portion 18 to cover fully the perforated portion 18. A backing material 60 is placed over a portion of the surface of the package 40 (interior or exterior) as well as the peripheral surface 24 of the film cover 55 along the edges thereof to secure the film cover 55 to the package 40.

In various aspects, the method may be used with unperforated packaging. When the method is used with unperforated packaging, or with existing partially perforated packaging that requires additional perforations, the method includes forming a plurality of spaced-apart holes or perforations 50 into the a package 40. The perforations may be formed by any suitable known method, such as any form of laser perforating, needle perforating, or other perforating techniques to create a gas and moisture opening in a film or rigid container.

Unperforated packages 40 or unperforated packaging material prior to being formed into packages 40 may be passed through a perforator where the desired number of perforations 50 are placed in a desired configuration and in a desired location on each package 40 or material for forming a package. Laser perforators and services that provide laser perforation are commercially available. Other means of perforating or forming holes in packages may also be used.

Following perforation, the film 75 may be cut into desired configurations, the area of which exceeds the area of the configurations of the perforated portions 18 of the packages 40 or packaging material. Alternatively, the film covers 55 may be pre-formed into the desired configurations and the perforations on the packages made to be smaller than the configurations of the film covers 55. In either case, sufficient area along the periphery 24 of the film cover 55 is provided to allow for attaching the film cover 55 to the perimeter 22 of the perforated portions 18 of the package 40 so that the adhesive material or adhesive backing material or film does not cover the perforations 50. While some overlap may be tolerated, the perforations 50 are desirably not compressed or blocked by the adhesive, adhesive backing or layer, or the backing material.

In various aspects, the peripheral surface 24 of the film cover 55 that is intended to contact the perimeter 22 of the perforated portion 18 is coated with an adhesive. In alternative aspects, a backing material 60 is attached to the peripheral surface 24 of the film cover that is intended to contact the perimeter 22 of the perforated portion 18. The backing material 60 may be coated with an adhesive or may itself be in the form of an adhesive material. In another aspect, the backing material may be in the form of a layer of an adhesive coated film that is attached to the peripheral surface 24 of the film cover that is intended to contact the perimeter 22 of the perforated portion 18. Alternatively, the package 40 is overlaid by the film cover 55, and the backing material 60 may then be placed over both a portion of the surface of the package 40 and the overlying peripheral surface 24 of the film cover 55 along the edges thereof to secure the film cover 55 to the package 40.

In various aspects of the method, the film cover 55, cut to the desired size and shape and coated with an adhesive, adhesive backing, or a layer of a film or backing material coated with an adhesive, is placed over the perforated portion 18 to cause the film cover 55 to fully cover the perforated portion 18. The peripheral surface 24 is pressed against the perimeter 22 of the perforated portion 18 to seal the perimeter 22 to the film cover 55 to thereby create a seal between the film cover 55 and the package 40. In certain aspects, the film cover may be attached to the exterior 14 of a package 40. In certain aspects, the film cover may be attached to the interior 16 of a package 40. When placed on the interior side 16 of the package 40 to cover the perforations from the inside, the film is preferably a permeable film. Whether placed on the inside or the outside of the package, the film cover 55 is applied over the perforated portion 18 either sealed or loose to the package 40.

In various aspects of the method, the film cover 55, cut to the desired size and shape, but not coated with an adhesive, is placed over the perforated portion 18 to fully cover the perforated portion 18, followed by the separate application of a backing material 60 to the periphery 24 of the film cover 55. The backing material 60 is placed over both a portion of the surface of the package 40 (interior or exterior) and the peripheral surface 24 of the film cover 55 along the edges thereof to secure the film cover 55 to the package 40. The backing material 60 seals the peripheral edges of the film cover 55 to the package 40 to enclose the film cover 55 over the perforations 50. Sealing may occur by any suitable means, such as with use of an adhesive or by heat staking, in the manner described above.

With reference to FIG. 1, the package 40 includes holes or perforations 50. However formed, the perforations 50 provide fluid communication between the interior 16 of the package 40 and the immediate or proximate exterior 14 of the package 40.

The film cover 55 may be made of any of the materials described above with reference to FIGS. 2-6. A preferred material is a three phase polymer. A preferred commercially available polymer sold under the mark Activ Film™, is particularly suitable for food storage. Activ-Film™ materials, commercially available from Aptar CSP Technologies, are available in thicknesses typically ranging from 0.3 to 1.2 mm, although other thicknesses are available. The extruded films can be dropped into a container or can be affixed to an interior surface using adhesive, or heat staking to a compatible sealing layer of an enclosure using a combination of heat and pressure according to the process described in U.S. Pat. No. 8,142,603. Activ-Film™ formulations can absorb a variety of gases, including moisture, oxygen, and volatile organic compounds. Activ-Film™ materials can also release gases such as carbon dioxide (CO2) and chlorine dioxide (ClO2).

In various aspects, the film cover 55, when applied directly over the perforations 50, is in fluid communication with the interior 16 of package 40 but not in direct physical contact with the contents of package 40. Although shown in FIG. 1 in a linear array, the perforations 50 may be formed in any position and in any configuration in the package 40. The film cover 55 and the perforated portion 18 may be configured in any shape (e.g., circles, ovals, squares, triangles, rectangles, crescent-shaped, arcs, in letters, numbers or other indicia, or any other curved or rectilinear shape or combination thereof).

In various aspects, backing material 60 may be a polymer. In various aspects, as described elsewhere herein, backing material 60 seals the film cover 55 to the package 40, for example, at the edges or periphery 24 of the film cover 55. This process allows for in-line application of film cover 55 to any pre-made package 40.

In another alternative arrangement, the film cover 55 may itself be perforated and applied to the interior side of a package 40. In this aspect, the packages 40 would not be prefilled with the intended contents.

Applications for use of the methods described herein may vary. For example, the perforated packages 40 sealed with the polymer backed film cover 55 could be impregnated with an antimicrobial agent for food and/or a desiccant for dry materials. The perforated packages 40 covered with film covers 55 may be used for foods sold in bags or pouches, such as bagged salad, or produce. Foods that should not be exposed to moisture, such as dried pasta or flour, may be stored in bags impregnated with a desiccant. Perforated packages 40 covered with film covers 55 may be used for non-food items that should be kept moisture free, such as test strips.

All patents, patent applications, publications, or other disclosure material mentioned herein are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The following exemplary embodiments further describe optional aspects of the disclosed and claimed technology and are part of this Detailed Description. These exemplary embodiments are set forth in a format substantially akin to claims (each set including a numerical designation followed by a letter (e.g., “A,” “B,” etc.), although they are not technically claims of the present application. The following exemplary embodiments refer to each other in dependent relationships as “embodiments” instead of “claims.”

1A. A method of preserving a product in a package, the method comprising: attaching a cover film to a package, the cover film being attached to the package so as to cover a number of perforations extending through the package, the cover film including an antimicrobial releasing agent.

2A. The method of embodiment 1A, wherein the cover film is attached to an exterior of the package.

3A. The method of embodiment 1A, wherein the cover film avoids directed contact with a product in the package.

1B. A method of preserving a product in a package, the method comprising:
inserting a perishable product into a package, the package include a number of perforations extending there through; and
attaching a cover film to the package such that the cover film covers each of the number of perforations.

2B. The method of embodiment 1B, wherein the cover film is an entrained polymer film.

3B. The method of embodiment 2B, wherein the entrained polymer film includes a polymer base and an active agent.

4B. The method of embodiment 3B, wherein the entrained polymer film further includes a channeling agent.

5B. The method of any one of embodiments 1B-4B, wherein the cover film does not directly contact the product in the package.

The disclosed and claimed concept has been described with reference to various exemplary and illustrative embodiments. The embodiments described herein are understood as providing illustrative features of varying detail of various embodiments of the disclosed and claimed concept; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed and claimed concept. Accordingly, it will be recognized by persons having ordinary skill in the relevant art that various substitutions, modifications, or combinations of any of the exemplary embodiments may be made without departing from the scope of the disclosed and claimed concept. In addition, persons skilled in the relevant art will recognize, or be able to ascertain using no more than routine experimentation, many equivalents to the various embodiments of the disclosed and claimed concept described herein upon review of this specification. Thus, the disclosed and claimed concept is not limited by the description of the various embodiments, but rather is set forth in the claims.

1. A method comprising:
providing a package having an interior, an exterior, and at least a portion being a perforated portion having a number of perforations between the interior and exterior, the perforated portion having a perimeter;
positioning a film cover over the perforated portion of the package, the film cover having a peripheral surface, the film cover being made of a material that incorporates an active agent; and,
securing the peripheral surface of the film cover to the perimeter of the perforated portion of the package.

2. A method comprising:
providing a package having an interior, an exterior, and a perforated portion structured to allow gas and moisture flow between the interior and the exterior of the package; and
attaching over the perforated portion of the package a film cover made of a material that incorporates an active agent and structured to change the atmosphere within the package.

3. The method recited in claim 1 wherein the film cover is attached to the perforated portion on the exterior of the package.

4. The method recited in claim 1 wherein the film cover has an upper side and a lower side, and securing the peripheral surface of the film cover to the perimeter of the perforated portion comprises applying an adhesive to the lower side of the peripheral surface and contacting the lower side of the peripheral surface to the perimeter of the perforated portion of the package.

5. The method recited in claim 3 wherein applying an adhesive to the lower side of the peripheral surface comprises applying an adhesive backing material to the lower side of the peripheral surface.

6. The method recited in claim 1 wherein the film cover has an upper side and a lower side, and securing the peripheral surface of the film cover to the perimeter of the perforated portion comprises applying an adhesive backed material to the upper side of the peripheral surface and to a part of the exterior of the package surrounding the perimeter of the perforated portion such that the adhesive backed material overlaps the upper side of the peripheral surface and the part of the package exterior.

7. The method recited in claim 1 wherein securing the peripheral surface of the film cover to the perimeter of the perforated portion comprises heat staking the peripheral surface and the perimeter together.

8. The method recited in claim 1 wherein the method is carried out as a continuous process.

9. The method recited in claim 1 wherein the method is carried out as a batch process.

10. The method recited in claim 1 wherein the film cover is made of a material structured to change the atmosphere within the package.

11. (canceled)

12. The method recited in claim 10 wherein the active agent is one or both of an antimicrobial releasing agent and a desiccant.

13. The method recited in claim 1 wherein the film cover is made of a three phase material.

14. The method recited in claim 1 wherein the film cover is attached to the perforated portion on the interior of the package.

15. The method recited in claim 14 wherein the film cover is permeable.

16. The method recited in claim 2 further comprising, prior to providing the package, perforating at least a portion of a package.

17. A method comprising:
providing a package having an interior and an exterior;
perforating at least a portion of the package to provide a perforated portion of the package that allows gaseous flow between the interior and the exterior of the package; and
attaching over the perforated portion of the package a film cover made of a three phase material that incorporates an active agent.

18. The method recited in claim 17 wherein the film cover is attached to the perforated portion on the exterior of the package.

19. The method recited in claim 17 wherein:
the film cover has an upper side, a lower side, and a peripheral surface;
the perforated portion has a perimeter; and
attaching the film cover to the perforated portion further comprises applying an adhesive to the lower side of the peripheral surface and contacting the lower side of the peripheral surface to the perimeter of the perforated portion of the package.

20. The method recited in claim 19 wherein applying an adhesive to the lower side of the peripheral surface comprises applying an adhesive backing material to the lower side of the peripheral surface.

21. The method recited in claim 17 wherein:
the film cover has an upper side, a lower side, and a peripheral surface;
the perforated portion has a perimeter; and
attaching the film cover to the perforated portion further comprises applying an adhesive backed material to the upper side of the peripheral surface and to a part of the exterior of the package surrounding the perimeter of the perforated portion such that the adhesive backed material overlaps the upper side of the peripheral surface and the part of the package exterior.

22. The method recited in claim 17 wherein attaching the film cover to the perforated portion comprises heat staking a peripheral surface of the film cover to a perimeter of the perforated portion to seal the film cover to the perimeter of the perforated portion.

23. The method recited in 22 claim 17 wherein the method is carried out as a continuous process.

24. The method recited in 22 claim 17 wherein the method is carried out as a batch process.

25. The method recited in 22 claim 17 wherein the active agent of the three phase material is an antimicrobial releasing agent.

26. A package comprising:
an exterior surface and an interior surface;
at least a portion of the package being a perforated portion having a number of perforations extending between the interior and the exterior surfaces, the perforated portion having a perimeter;
a film cover made of a material configured to change the atmosphere within the package, the film cover being made of a material that incorporates an active agent, the film cover having a peripheral surface; and
the peripheral surface of the film cover being secured to the perimeter of the perforated portion of the package.

27. The package recited in claim 26 wherein the material is a three phase material incorporating an antimicrobial releasing agent.

28. The package recited in claim 26 wherein the material is a three phase material incorporating a desiccant.

29. The package recited in claim 26 further comprising a backing material in overlapping sealing contact with an upper surface of the peripheral surface and a part of the exterior of the package surrounding the perimeter of the perforated portion that is structured to secure the film cover peripheral portion to the perimeter of the perforated portion.

30. The package recited in claim 29 wherein the backing material is heat staked to the package.
